(19) United States
(12) Patent Application Publication
(10) Pub. No.: US 2025/0089679 A1
(43) Pub. Date: Mar. 20, 2025

(54) SYSTEM AND METHODS FOR QUANTIFYING ANIMAL BEHAVIOR AND WELFARE WITH REAL-TIME WIRELESS TELEMETRY EQUIPPED INSTRUMENTED ENRICHMENT OBJECT

(71) Applicant: Georgia Tech Research Corporation, Atlanta, GA (US)

(72) Inventors: Charles Ramey, Atlanta, GA (US); Melody Moore Jackson, Atlanta, GA (US); Thad Eugene Starner, Atlanta, GA (US)

(21) Appl. No.: 18/891,207

(22) Filed: Sep. 20, 2024

Related U.S. Application Data
(60) Provisional application No. 63/539,401, filed on Sep. 20, 2023.

(51) Int. Cl. A01K 15/02

(52) U.S. Cl. CPC A01K 15/025

(57) ABSTRACT

An exemplary embodiment of the present disclosure provides a system for generating behavior profiles using an enrichment object such as an enrichment object, the system comprising at least one enrichment object comprising at least one magnetic sensor, at least one processor, and a memory. The memory can be in communication with the at least one processor and the at least one magnetic sensor, and can have stored thereon instructions that, when executed by the at least one processor, is configured to cause the system to analyze sensor data received in real time from the at least one magnetic sensor, and generate a behavioral profile based, at least in part, on the analyzed sensor data.

### CROSS-REFERENCE TO RELATED APPLICATIONS

This application claims priority to U.S. Provisional Patent Application No. 63/539,401, filed 20 Sep. 2023, which is hereby incorporated by reference herein in its entirety as if fully set forth below.

### GOVERNMENT LICENSE RIGHTS

This invention was made with government support under Agreement No. GR00021785, awarded by the Department of Homeland Security. The government has certain rights in the invention.

### FIELD OF THE DISCLOSURE

The various embodiments of the present disclosure relate generally to systems and methods for quantifying animal behavior, and more particularly to using real-time wireless telemetry equipped instrumented enrichment object to quantify animal behavior and welfare.

### BACKGROUND

In captive environments (such as zoos and aquariums) as well as home environments (in the case of pet animals), direct supervision of animals by veterinarians is extremely limited. Additionally, the ability of non-human and human animals to communicate about the health and welfare of non-human animals in human care is extremely limited. For these reasons, there is great utility in autonomous sensing technologies for the quantification of animal activities and behaviors.

In conventional methods, monitoring animal health and behavior often relies heavily on observation and periodic check-ups, which can be both time-consuming and prone to error. These traditional approaches are limited by the frequency and duration of observations, often missing critical changes in an animal's condition that occur outside of scheduled monitoring times. Additionally, conventional methods lack the precision and consistency required to capture subtle behavioral nuances or physiological changes. The reliance on human interpretation also introduces subjectivity, which can lead to inconsistent data collection and analysis. Furthermore, traditional enrichment objects, such as toys, do not provide any feedback or data on how animals interact with them, making it difficult to assess the effectiveness of these tools in promoting animal welfare.

These limitations highlight the need for more advanced, automated systems that can provide continuous, objective, and detailed monitoring of animal health and behavior. Embodiments of the present disclosure can allow animal caretakers to better monitor the animals under their care and intervene more quickly in the event of abnormal health or behavioral conditions.

### BRIEF SUMMARY

An exemplary embodiment of the present disclosure provides a system comprising at least one enrichment object comprising at least one magnetic sensor, at least one processor, and a memory. The memory can be in communication with the at least one processor and the at least one magnetic sensor, and having stored thereon instructions that, when executed by the at least one processor, is configured to cause the system to analyze sensor data received in real time from the at least one magnetic sensor, and generate a behavioral profile based, at least in part, on the analyzed sensor data.

In any of the embodiments disclosed herein, the sensor data can be received in real time in response to a user interacting with the at least one enrichment object.

In any of the embodiments disclosed herein, the user can interact with the at least one enrichment object in an environment comprising at least three magnetic sensors placed in known arrangements to track a relative posturing of the system relative to the user.

In any of the embodiments disclosed herein, the memory, when executed by the at least one processor, is further configured to cause the system to transmit a signal to an imaging device in an environment comprising the at least one enrichment object to initiate or terminate video data collection.

In any of the embodiments disclosed herein, the memory, when executed by the at least one processor, is further configured to cause the system to transmit a signal to an environmental stimulus in an environment comprising the at least one enrichment object.

In any of the embodiments disclosed herein, the environmental stimulus can be a reward for the user interacting with the at least one enrichment object.

In any of the embodiments disclosed herein, the user can interact with the at least one enrichment object in an environment. The at least one enrichment object can be a plurality of enrichment objects and the memory, when executed by the at least one processor, can be further configured to cause the system to simultaneously receive the sensor data and state data from the plurality of enrichment objects. The state data can comprise mechanical or electrical failures of a corresponding enrichment object in the plurality of enrichment objects.

In any of the embodiments disclosed herein, the at least one enrichment object can be a silicone enrichment object further comprising at least one accelerometer, at least one gyroscope, or at least one barometer.

In any of the embodiments disclosed herein, the sensor data can be additionally received from the at least one accelerometer, the at least one gyroscope, or the at least one barometer. The sensor data can be automatically segmented, and the sensor data can be analyzed using a machine learning model by automatically detecting activities in the sensor data associated with the user interacting with the at least one enrichment object. The sensor data can be segmented based on the detected activities and be used to generate the behavioral profile using the machine learning model by detecting patterns between the sensor data and the detected activities.

In any of the embodiments disclosed herein, the machine learning model can be configured to dynamically generate a visual of the sensor data. The memory, when executed by the at least one processor, can be further configured to cause the system to transmit in real time the sensor data or the visual of the sensor data to an external device.

In any of the embodiments disclosed herein, a level of work readiness of the user can be determined based on the behavioral profile of the user by comparing patterns of play in the behavioral profile to a current state of play.

In any of the embodiments disclosed herein, the sensor data can be additionally received from the at least one accelerometer, the at least one gyroscope, or the at least one barometer. The sensor data can be automatically analyzed using a machine learning model to detect at least one signal from the user interacting with the at least one enrichment object.

In any of the embodiments disclosed herein, the user can interact with the at least one enrichment object in an environment, and the at least one signal can be based on a bite pressure or a movement of the at least one enrichment object from the user.

In any of the embodiments disclosed herein, the at least one signal can mark a location of the environment for a handler of the user.

An exemplary embodiment of the present disclosure provides a method comprising analyzing sensor data received in real time from at least one magnetic sensor in at least one enrichment object, and generating a behavioral profile based, at least in part, on the analyzed sensor data.

In any of the embodiments disclosed herein, further comprise transmitting a signal to an imaging device in an environment comprising the at least one enrichment object to initiate or terminate video data collection.

In any of the embodiments disclosed herein, further comprise transmitting a signal to an environmental stimulus in an environment comprising the at least one enrichment object.

An exemplary embodiment of the present disclosure provides an enrichment object comprising a silicone shell, at least one sensor inside of the silicone shell, at least one processor; and a memory. The memory in communication with the at least one processor and the at least one sensor, and having stored thereon instructions that, when executed by the at least one processor, can be configured to transmit sensor data from the at least one sensor to a computing device for a generation of a behavioral profile based, at least in part, on the sensor data.

In any of the embodiments disclosed herein, further comprise charging hardware configured to enable wireless charging of the at least one sensor through the silicone shell.

In any of the embodiments disclosed herein, further comprise automatically detecting activities in the sensor data associated with a user interacting with the enrichment object, wherein the sensor data is segmented based on the detected activities and generating the behavioral profile in real time using a machine learning model by detecting patterns between the sensor data and the detected activities.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides an image of an exemplary an outer ball and an inner ball.

FIG. 1B provides an image of an exemplary electronics and batter that can be placed inside the inner ball.

FIG. 2A provides an image of an exemplary electronics being inserted inside the inner ball.

FIG. 2B provides an image of an exemplary assembled ball.

FIG. 3 provides an image of an instrumented dog toy utilized with an over-molded tennis ball and a potted electronics assembly.

FIG. 4A provides an image of an exemplary electronics assembly being soldered together.

FIG. 4B provides an image of an exemplary electronics assembly potted in silicone.

FIG. 4C provides an image of an exemplary a potted assembly removed from mold and a vent hole that was cut for a barometer.

FIG. 4D provides an image of an exemplary a potted assembly inserted into a tennis ball.

FIG. 5 provides an image on the left of a core tennis ball positioned within the mold using the top alignment jig and a TRS plug inserted into a charging port. FIG. 5 further provides a middle image of a bottom half of a mold that was filed with silicone. FIG. 5 further provides an alignment jig removed and a top half of a mold injected with silicone. As the silicone is pushed in, air is pushed out of the equatorial vent holes.

FIG. 6 provides an image of a magnetic soft switch circuit schematic. The S1 component is the magnetic reed switch which is used to establish a momentary powered on state. Once the magnetic switch is activated, voltage flows from the battery to the ESP-32 microcontroller. The ESP-32 is then able to control power to itself by pulling the KEEP_On signal to 5 v or 0 v.

FIGS. 7A and 7B provides images of exemplary common mode of mechanical failures of silicone breaking apart around electronics assembly flanges.

FIG. 8 provides an exemplary method flow chart of using an enrichment object such as a ball.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Various systems, methods, and computer-readable mediums are disclosed and will now be described.

Enrichment objects, colloquially referred to as toys such as balls or sticks, are often provided to captive and pet animals to allow them to exhibit natural foraging and hunting behaviors. These toys encourage animals to engage in playful behaviors, which are both mentally and physically beneficial to their health. By incorporating digital sensors into enrichment objects, the actions taken by animals interacting with the objects can be quantified. Quantified interaction measurements taken over time or across different environmental or medical conditions can be utilized to profile an individual animal's overall behavioral characteristics or general physiological and psychological welfare. Some embodiments of the present disclosure provide a system that equips an instrumented enrichment object (or a “smart toy”) with real-time wireless telemetry. In particular, the present disclosure includes a ball as a smart toy, which has sensors for real-time wireless telemetry and additional embodiments described further below.

Some embodiments of the instrumented enrichment device disclosed herein can be designed to be a chewable ball for dogs. This chewable ball can be constructed with food-safe rated silicone and features an all-silicone construction with a hollow inner cavity. The hollow center cavity can allow for pressure readings to be taken while the ball is being chewed. In some non-limiting embodiments, the chewable ball can be solid (without a hollow center cavity) and can be made of a silicone material. The all-silicone ball can have varying wall thickness, and the overall diameter of the ball can be increased or decreased to adapt to various sizes and strengths of an animal. To produce a self-contained ball with no exterior surface penetrations for charging or maintenance, the design can rely on wireless charging, wireless telemetry, and magnet swipe-based control. The ball can be water-proof and can be sterilized. By optimizing the design to hold the electronic sensing package at the center of the ball, the present disclosure can utilize Qi charging for recharging the ball's internal battery. Through a combination of a reed-switch-based latching circuit and a magnetometer sensor, the ball can be switched on and off with the swipe of a magnet. Finally, the ball transmits telemetry in real-time over Wi-Fi, allowing for real-time data collection and device diagnostics.

While this technical description describes one specific implementation of the instrumented enrichment objects, the present disclosure is not limited to dogs. Instrumented enrichment objects with real-time wireless telemetry systems can be made for any species of animal conditioned to interact with enrichment objects. In an effort to better understand the unique behavioral characteristics of individual service and working dogs, researchers are developing instrumented play toys. By utilizing an inertial measurement unit and barometric pressure sensor, the instrumented toys can capture quantitative data while dogs play with the objects. Quantified play data can provide insight into the internal structure of an individual dog's interactions by analyzing features such as bite force, frequency, and shaking-based “kill behaviors.” Prior anecdotal data have shown evidence that play behaviors over time may even enable the detection of medical symptoms in individual dogs. The first iteration of instrumented toys has shown success in predicting the training outcomes for service dogs. In this application, the present disclosure presents the most recent iteration of instrumented toys, discussing the improvement of the overall usability of the toys, as well as the development of a well-controlled and consistent manufacturing process. Furthermore, several mechanical and electrical changes have been adopted to achieve a high level of safety as dogs interact with the devices.

The present disclosure aims to create instrumented toys to collect quantitative data on dog play behaviors. By collecting data during play sessions, researchers can better understand the relationship of play to overall canine health and well-being. The current project implementation can be a food-safe silicone over-molded tennis ball with an embedded sensor package at its center. These embedded sensors can collect motion data via an inertial measurement unit (IMU) and pressure data via a barometer as dogs interact with the ball. By collecting data from interactions over time, the present disclosure can develop machine learning models that can quantify dog temperament elements known as behavioral phenotypes. These models, along with subjective and objective measurements from veterinarians, can improve the efficiency and quality of training programs for service and working dogs. Creating interactive toys for dogs, however, can have challenges from a technical perspective. A primary challenge is creating an object that is as safe as possible for dogs to interact with. Secondary to this challenge is the ruggedization aspect, which ensures that when dogs interact with the toys, the electronics can survive and collect useful data. Finally, there are practical usability considerations that require overall system to be easy to deploy and maintain. In practice, the first two challenges can have the device fabrication materials be food-safe, a reduction in discontinuities in the exterior surface of the devices, and that the devices be manufactured to a high level of uniformity. The usability considerations can have feedback and telemetry automation to create a system that anyone can use. The present disclosure presents the two previous iterations of this project, which have been utilized in several longitudinal studies for examining dog behavioral phenotypes. A contribution of this present disclosure is, however, the presentation of recent improvements to the overall device design, manufacturing process, and software. By implementing a TRS plug-based charging system and a reed switch-activated latching soft switch circuit, the present disclosure can enhance the battery life of the units and minimize external openings. Additionally, a low-pressure silicone injection process was utilized to boost the uniformity of devices across manufacturing batches with minimal air bubbles present in the resulting castings. Finally, embedded firmware and supporting software were developed to improve the overall ease of use during system deployments. By sharing the project's design choices and fabrication process, the present disclosure aims to lower the barrier for the creation of food-safe, embedded interactive sensing systems for future human-computer interaction (HCl) and animal-computer interaction (ACI) researchers.

For instance, the utilities the present disclosure offers can include quantifying the effect of medication(s) on animals, detecting illness and injury, measuring environmental reactivity in animals (useful in the training and selection process of assistance canines as well as nose work canines), behavioral phenotyping of animals, performance monitoring in dog sports (such as flyball and agility), hormonal cycle tracking, fertility tracking, physical fitness level characterization, and longitudinal monitoring of injury recovery. Some embodiments of the present disclosure, while an animal interacts with the object, can have an embedded computer system that transmits measurements from sensors to a nearby data collection terminal. The sensor measurements can be taken over a period of time to create a profile of the animal's behavioral characteristics or psychological welfare. The system can segment the sensor measurement in real time and diagnose electrical and mechanical problems with the object during data collection sessions. In some embodiments, the environmental object can be a hollow all-silicone food-safe ball using sacrificial 3D-printed molds, which allows for the incorporation of internal structures. The hollow center cavity can allow for pressure readings to be taken while the ball is being chewed.

A pairing of real-time wireless telemetry with instrumented enrichment objects allows for the synchronization of WiFi-enabled cameras and environmental stimulus as well as affords the ability to recognize behaviors in real-time, automatically segment data based on sensor measurements, and diagnose electrical and mechanical problems with instrumented enrichment objects in real time during data collection sessions. The present disclosure is the first to equip instrumented enrichment objects with real-time wireless telemetry. Within this system, there are many advantages presented: 1) The QI-based wireless charging system utilized by the instrumented enrichment objects can utilize a novel alignment technique and charging status feedback system. 2) The present disclosure can have a technique for calibrating each instrumented enrichment object. 3) The present disclosure can have a manufacturing technique for constructing hollow all-silicone food-safe balls using sacrificial 3D-printed molds. 4) Embodiments of this method can allow for the incorporation of internal structures for the mechanical strengthening of silicone enrichment objects. 5) Embodiments of the system can utilize a wireless pendant device for monitoring multiple enrichment objects simultaneously and can provide notification of possible mechanical or electrical failures. 6) By incorporating 3 degrees of freedom magnetic sensors into an activity monitor and enrichment objects, the present disclosure can utilize known placements and arrangements of magnets to track the relative positioning and posturing of enrichment objects relative to animals interacting with them. 7) By utilizing magnets of known polarity arrangements in known placements throughout the environment, activity data can automatically be segmented for data analysis and machine learning. 8) WiFi signals can be emitted via the real-time wireless telemetry protocol to automatically start and stop video data collection as well as automatically segment data during collection sessions. 9) WiFi signals can be emitted via the real-time wireless telemetry protocol to automatically trigger environmental stimulus while animals are interacting with the objects as a reward for engagement or as an avenue for quantifying reactivity.

Some instrumented objects of the present disclosure can encapsulate a microcontroller and digital sensors within custom-fabricated animal-safe toys. While animals interact with the instrumented toys, the embedded computer system can transmit the sensor measurements and system information in real-time to a nearby data collection terminal. By leveraging sensors embedded within toys along with wireless real-time telemetry, embodiments of the present disclosure can collect data that is more specific to particular play interactions and activities compared to existing wearable-based activity monitoring products alone. Some embodiments of the chewable ball device for dogs can leverage a unique construction methodology to produce devices of various sizes and hardnesses.

Commercial applications of some embodiments disclosed herein can include the behavioral and health monitoring of captive and pet animals. Prior research with these devices has demonstrated the effectiveness of instrumented enrichment objects for scoring the likelihood of training success for potential working dogs. Organizations that train and utilize working dogs such as the Department of Homeland Security, TSA, and Canine Companions for Independence can gain substantial efficiency and cost savings by integrating instrumented enrichment objects into their candidate evaluation protocols. Additionally, beyond the prior demonstrated ability of instrumented enrichment objects for predicting training outcomes, some embodiments have the capability for long-term health monitoring. Utilizing these devices for health monitoring would allow pet owners and caretakers to quantify their animal's activity levels and play behaviors over time. These long-term measurements can assist when sudden departures from average activity levels or activity types occur. In these instances, the devices can point out to owners or caretakers that special attention is required for an individual animal who is acting differently.

Prototyping Devices for Interactions with Dogs

An emerging focus of research within Animal-Centered Computing has been the creation of devices for monitoring the health of and augmenting the experiences of dogs. Westerlaken and Gualeni examine the process of becoming with as a method for providing insight into how shared toy interactions and decisions occur between humans and animals. Wallis et al. utilized a touchscreen-based automated treat dispenser to explore enrichment activities for aging dogs to promote cognitive welfare. Byrne et al. explored instrumented chew and tug toys to determine the viability of individual dogs to become assistance canines. Foster et al. have integrated electrocardiogram and inertial measurement into working dog vests to provide more quantifiable data for the assessment of guide dogs. Hirskyj-Douglas et al. explore balls with sensors embedded within to allow dogs to call their owners over the internet. The present disclosure can create a sensor platform for dogs to engage with so caretakers and trainers can monitor the health and behavior of dogs without altering traditional canine-human interactions. The present disclosure can focus on building hardware that is hardy enough to withstand dog biting and chewing while utilizing materials that are safe for dogs to chew and bite. Additionally, the project implements several features, including automated telemetry and magnetic switching, that can increase usability for researchers deploying the devices.

### Standard for Prototypes

Utilizing sensors to quantify the behavior and physiological state of humans and animals has been a common goal for researchers in HCl and ACI. Within HCl, researchers have leveraged instrumented children's toys to assess the behavioral characteristics of children. Further, instrumented toys have also been created to monitor the health of children through their interactions. These projects have demonstrated the feasibility of behavioral and physiological monitoring via instrumented toys with human research participants. Since these works involved children handling research prototypes, some works such as Wang et al., note that prototype material selection should be driven by safety. The work by Vonach et al. specifically manufactured prototype parts that were intended to be placed in a child's mouth. When human or non-human animals are placing prototype hardware in their mouths, it is important that those materials are non-toxic and non-porous in order to prevent harm to the user. The present disclosure demonstrates a set of methods and materials which can be utilized to create wet-contact, food-safe research prototypes.

### Bite Force Estimations for Projected Users

Tools for measuring bite force continue to be developed, however, the present disclosure can provide an approximation of bite forces per breed and by weight. Hyytiäinen et al. constructed a bite sleeve embedded with compression force sensors and found that on average German Shepherd Dogs (GSD) (n=7) and Belgian Shepherd Dogs, Malinois (BSDMs) (n=13) police dogs produced a median bite force of 360.4 N and 247.0 N, respectively. Lindner et al. used a rawhide-covered force transducer to measure bite force across 22 pet dogs that range in weight and size. On average, dogs ranging between 11 and 23 kgs exhibited 168 N of bite force, with a range of 66-340 N. Dogs ranging between 23 and 34 kgs had a mean bite force of 180 N (range 40-367 N) and dogs heavier than 34 kgs had a mean bite force of 442 N (range 184-937 N). The present disclosure can expect dogs to exhibit a bite force of anywhere between 44 N and 937 N.

### Implementations

### Enrichment Object: First Variation

The present disclosure's original goals for the toys were pared down from the goals stated in the introduction. The toys could be durable enough to last through many uses by at least several dogs without degradation, while also being safe for the dogs to use. They could be washable between uses to remove testing effects between dogs. The shell of the ball could protect the electronics; however, one of the goals for a service dog is a “soft mouth,” which allowed for softer material. Lastly, the present disclosure opted out of using wireless data transfer, which meant that access to the electronics inside the ball was used.

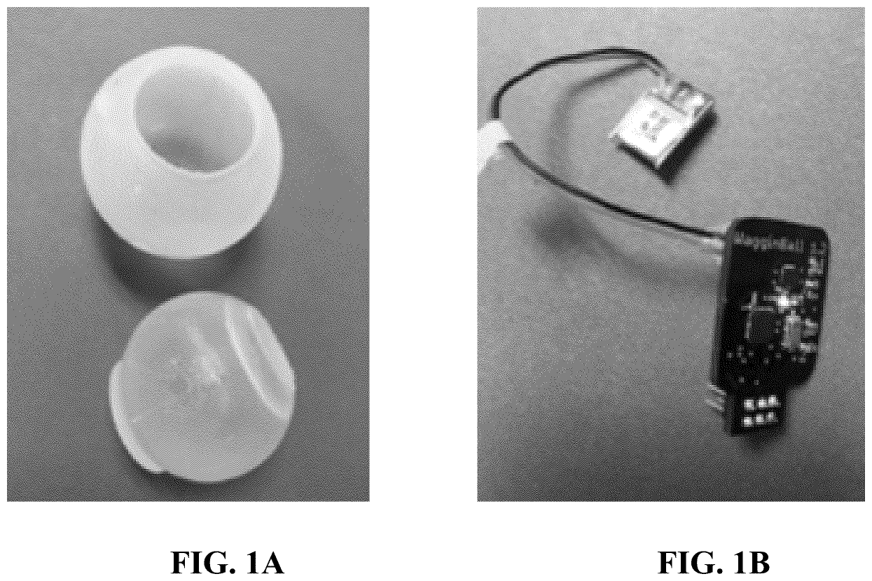

Ball Construction. The final design comprised three elements: two silicone interlocking balls, (1) one inner and (2) one outer that formed a single ball when assembled, and (3) the electronics. As shown in FIGS. 1A and 1B, the inner ball (bottom) has an opening to accommodate inserting the electronics and has a locking mechanism to prevent the outer ball from rotating on the inner ball. Both the inner and outer interlocking balls were cast using the Platinum room-temperature curing (RTC), food-safe Smooth-Sil 940. The present disclosure chose a translucent material to allow for observing status lights inside, indicating when the had power. The balls were cast using 3D-printed three-part negatives; two parts formed the exterior surface and one part shaped the interior surface. The silicone used was malleable enough to remove the interior mold without ripping the ball.

Electronics. The outer ball has an opening to allow the insertion of the inner ball. The outer ball protects the electronics and the inner ball provides air space for the barometric pressure sensor to operate. When a dog bites the sensor, the air pressure inside the ball increases, and the electronics record the pressure on a microSD card. The electronics comprised a custom printed circuit board (PCB) which includes a barometer (MPL115A1T1) as well as an accelerometer, gyroscope, and magnetometer (MPU9250). The accelerometer allows the present disclosure to capture movements, such as the shaking involved in some kill behaviors. The gyroscope lets the present disclosure measure movement “gestures,” as well as detecting a rolling ball. Combined, the accelerometer and gyroscope data aids in characterizing the intensity and duration of a dog's play behaviors. The magnetometer allows the present disclosure to perform a sync trigger with a small magnet to synchronize data collection with video recordings. FIGS. 1A and 1B show the electronics inside the inner ball being inserted into the outer ball, and then the assembled ball.

Lessons Learned. Moving forward from this iteration, the goal was to create toys for more powerful breeds such as Malinois or German Shepherd dogs. Improvements to both device construction and electronics would be useful to improve durability and usability. Below, the present disclosure categorizes what was learned during iteration 1.

Construction Improvements. Initially, the dogs could bite hard enough to puncture the silicone and consequently damage the electronics inside. Increasing the silicone durometer and wall thickness could prevent the ball from being punctured. Additionally, some of the harder-biting dogs could compress the outer ball enough that the inner ball could rotate inside of it, allowing the electronics to be exposed. This problem was exacerbated by the fact that the dog's saliva could lubricate the two pieces of the ball to allow them to slip more easily. Consequently, dogs who interacted longer were more likely to rotate the inner ball. The present disclosure considered making the ball one solid piece. This solid construction would have the added benefit of minimizing damage to the internal components. Additionally, since the ball would not need to be disassembled to upload the data and change the battery, data collection would be more streamlined.

Electronics Improvements. In general, the electronics did not fail unless the ball was punctured. However, there were instances of the battery being unplugged or the SD card being ejected by bites that perfectly aligned with those junctures. The present disclosure solved this by wrapping the inner electronics in soft fabric to cushion them and to keep them from moving around inside the inner ball.

### Enrichment Object: Second Variation

Version 2 was centered around taking what the present disclosure learned from the first version, consolidating the components into a suite of sensors fully enclosed in a tennis ball and over-molded with Smooth-On Smooth-Sil 960 Shore 60A platinum cure silicone.

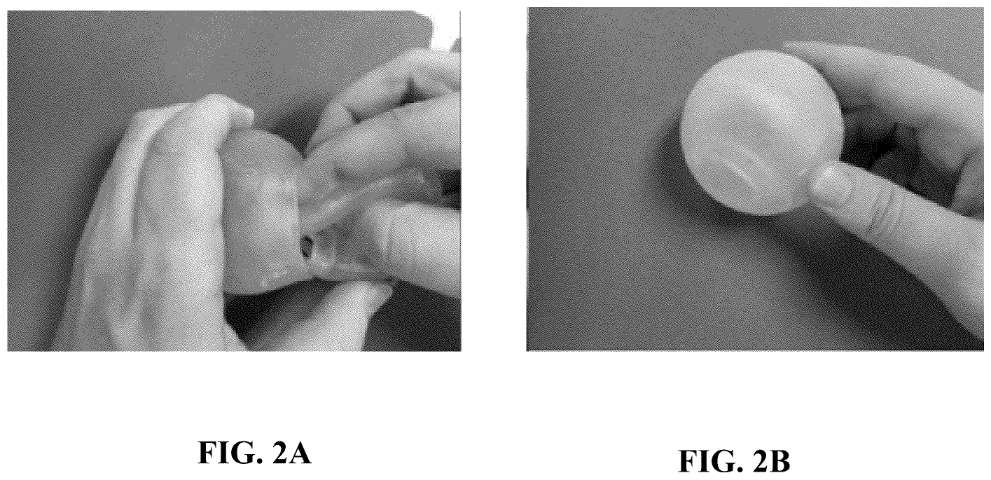

Ball Construction. To upgrade the durability of version 2 prototypes, the present disclosure utilized a tennis ball as the core structural element and included a potted electronics assembly to protect the sensors. As shown in FIG. 2, the electronics assembly can be inserted into a hole in the tennis ball core. A flange can be integrated into the electronics assembly during potting which prevents the assembly from fully sliding inside of the tennis ball. Additionally, the flange constrains the electronics assembly such that the accelerometer is positioned in the center of the ball. Once the electronics assembly is inserted, silicone is over-molded around the ball such that there was approximately 3 mm of silicone encapsulating the instrumented ball. In order to accommodate the tennis ball core, a three-stage casting process utilizing 3D-printed molds was used. First, the electronics assembled were potted. Next, the bottom of the ball was covered in silicone. Finally, the top half of the ball was covered with silicone. To pot the electronics in silicone, a mold was made from a 3D-printed positive form in the desired final shape of the electronics puck. A unique challenge to this potting process is maintaining an air channel from the barometer to the inner tennis ball. To maintain an air channel, tape is placed over the barometer during potting. Once the silicone is fully cured, a hole can be cut into the silicone and the protective tape can be removed.

Electronics. The electronics comprised two custom printed circuit boards (PCBs). The first PCB can include an ESP32 microcontroller, the same barometer as iteration 1, and a new 9-DOF IMU (BMX160). The second PCB can include a micro-USB port, LiPo charge management IC, and a boost converter to regulate the LiPo's output. Lastly, the present disclosure can include a vibration motor to provide state feedback to the user. When a dog bites the ball or moves the ball, the air pressure inside the ball increases and the inertial measurements change. As sensor data are captured, the readings can be recorded using the onboard SPI Flash File System (SPIFFS).

Software Overview. The final software can include four states: system startup, data collection, data transfer, and system reset. State transitions were activated when a magnet was applied to the outside of the ball. The fully enclosed construction of the second iteration and the opacity of the material, however, meant that there was zero visibility into the system's state as the present disclosure was running studies. The interpretability of the state of the device was integral to the success of the project, as the present disclosure needed to ensure that accurate data was being collected and uploaded. This interpretability was achieved through vibration patterns emitted from the internal vibration motor as state transitions were activated.

Lessons Learned. Construction Improvements. The present disclosure tested the final design of version 2 on a population of working dogs. The failure points were primarily due to material degradation from repeated compression. Surprisingly, the material degradation was not limited to the area where the epoxy surrounding the sensor met the silicone rubber. Over the course of about 16 sessions, micro-fractures developed in the rubber where the rubber would pull back from the tennis ball. While the felt on the tennis ball provided strength and added surface area for the silicone to adhere to, it also led to failure points.

Usability Improvements. While much thought had gone into the development of the four software states, a log of which state the software was in was maintained. Training new users to work with the system can be difficult depending on the level of technology a user was accustomed to. Additionally, due to storage capacity and WiFi connection reliability, some data in the pilot studies was lost. The present disclosure improved upon this in Version 3.

### Enrichment Object: Third Variation

### Ball Construction

To further streamline the fabrication process and continue to improve the mechanical reliability of the balls, the version 3 prototypes made improvements to the casting process from the version 2 balls. The main difference between the version 2 and 3 processes involves how the upper mold section is filled. Since version 2 relied on gravity to fill the upper mold section and no vent holes were included in the mold aside from the fill tube, air bubbles would often get trapped within the mold. Additionally, the high-viscosity silicone proved difficult to pour into the small (⅜ inch diameter) mold fill tube. To circumvent these issues, the present disclosure redesigned the molds and utilized a low-pressure injection system for the version 3 prototypes.

The version 3 molds were designed with vent channels running across the mold's equator to allow air to escape as silicone is pushed in from the top mold half. During this new casting process, the first two steps are the same as from version 2: the electronics are potted in silicone, and the lower ball half is cast using displacement. Next, however, a caulking gun can be used to inject silicone into the upper mold section. As the silicone is pushed in from the top, any air in the mold is pushed out through the vent holes running through the mold's equator. Silicone injection is stopped once liquid silicone is uniformly ejecting from all vent holes which indicates all air has been pushed out and silicone has filled the upper mold cavity.

### Electrical Improvements

In the interest of maintaining sensor continuity between prototypes, the version 2 sensor suite circuit boards were also utilized in version 3. The power management circuit board from version 2, however, was completely overhauled for version 3. Two primary improvements were incorporated into the new power management circuit board: a TRS charging port and a magnetic field-activated soft power switch.

TRS Charging Port. To enable charging via a mechanical connector while isolating the female receptacle inside the ball from possible contact with dog teeth, a 2.5 mm diameter TRS connector was selected for charging. Commercially available TRS charging cords were selected which have a USB A male connector on one end and a 2.5 mm diameter, 7 mm long TRS male pin on the opposite end. These cables allow the balls to charge from any USB A female power receptacle. During ball usage, the hole which allows access to the TRS receptacle inside the ball is filled with edible dielectric grease to prevent saliva ingress while dogs are chewing the ball.

Since this method involves placing the charging circuitry and charge connector deep within opaque silicone, a feedback mechanism internal to the ball is unable to provide status information during the charging process. To provide charging information to researchers while deploying and maintaining the system, USB power meters were incorporated into the external charging system. The USB power meters monitor the power supplied from USB A power receptacles as it is provided to the USB to TRS charging cables.

Magnetic Soft Switch. The version 2 prototypes utilized the ESP-32 microcontroller's deep sleep functionality to save power when the balls were not in use. Effectively, the “off” state of the balls was not truly powered off. Between uses, the balls were having to be periodically “topped off” with a charge to maintain readiness due to the continuous power draw. In order to enable a truer powered-off functionality, a magnetically activated soft switching circuit was developed. When the system is powered off in version 3, no power from the battery is allowed to flow to the main power rail of the electronics. If a magnet is placed near the reed switch, however, the ESP-32 microcontroller is able to power on and latch the circuit into the on state. The circuit remains in the continuous on mode (even when the magnet field is removed from near the reed switch) until the ESP-32 microcontroller is given a shutdown command and unlatches the circuit's on state. When the circuit is unlatched the entire system is powered off until a magnet reactivates the reed switch.

### Automated Telemetry

Since the sensor suite in version 2 is nearly identical to the suite in version 3, much of the software and telemetry remained the same between these two iterations. A notable exception, however, was the development of an automated data retrieval python script. The script, which runs on researchers' computers, automatically generates HTTP GET requests to download all files from toys that are hosting websites on the local network. The combination of an on-device web server with a python GET request script allows researchers to download all trial log files off of a toy's flash memory automatically.

### Enrichment Object Structure

While institutional review committees are typically included in the planning and provisioning of research involving the utilization of prototype embedded sensing systems, it is first and foremost the responsibility of researchers to select materials and design hardware with safety as the top priority. In the present disclosure, the focus on utilizing food-safe materials and minimizing the potential contact between animals and electronics has been a guiding design constraint.

An ongoing challenge for this work involves the utilization of tennis balls for the device's center air bladder. Tennis balls have provided a standardized starting point for the present disclosure's device constructions but impose constraints on both the size and hardness of the resulting dog toys. To collect data from a variety of dog breeds across a range of ages, the ability to create smaller and softer toys can be a requirement to adapt to smaller and younger dogs.

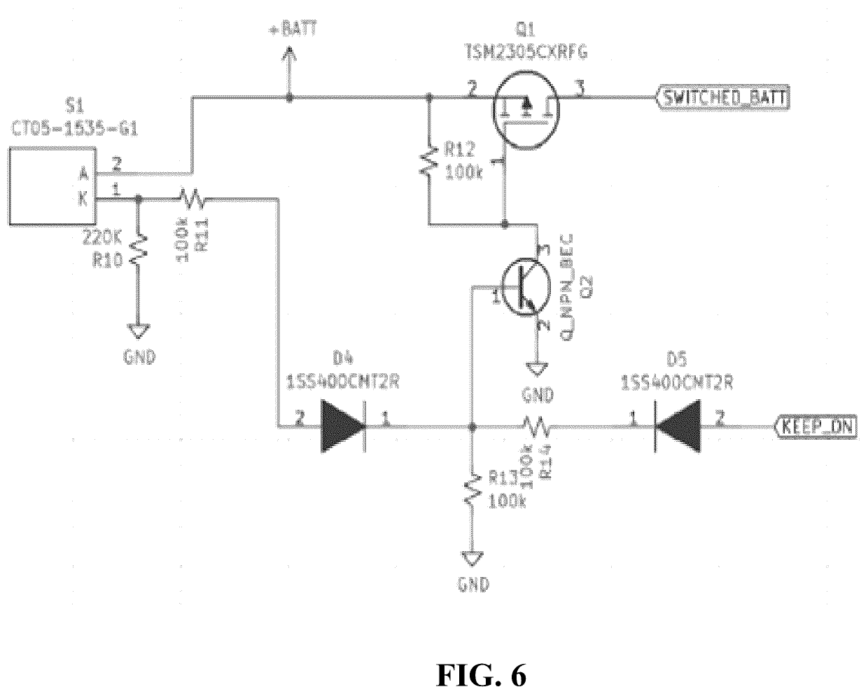

The dominant construction weakness of the instrumented toys is the bonding between the tennis ball and the silicone overmolding. As seen in FIG. 6, the silicone overmolding tends to tear, especially at thin points around the electronics flange, after repetitive stresses. To further improve the durability of the balls, a single material construction that omits the tennis ball would not experience failures from these bonding weaknesses.

Further, while the present disclosure's magnetic sync trigger, automated data retrieval scripts, and network time protocol (NTP) time synchronization have all made the devices easier to use, additional usability improvements are useful before the devices can be utilized outside of a laboratory environment by individuals other than researchers. To improve usability, a web application should be developed to show each device's status in real-time and allow users to switch software states remotely with graphical feedback.

Finally, before expanding the instrumented toys beyond a controlled laboratory setting, the exterior surface of the toys will need to be completely sealed. While the current TRS-based charging method is physically reliable, the hole for charge plug insertion is the most significant vulnerability on the toys' exteriors. To accommodate future unsupervised studies or studies which take place in harsh and wet environments, this charging hole can be removed entirely.

While the electronics, software, and physical construction of these instrumented dog toys is still progressing, the prototypes built so far have proven to be useful for collecting quantitative data on dog play behaviors. By utilizing a three-stage casting process with Smooth-On Smooth-Sil 960 platinum cure silicone, the present disclosure has been able to construct food-safe, durable, and functional prototypes. These prototypes have been engineered for ease of use by adopting electrical and software features such as a magnetically activated power switch, magnetic sync trigger, and automated telemetry. With the planned addition of wireless charging and a standardized calibration procedure, these instrumented objects are ready for utilization in several longitudinal studies with assistance and working dogs. The food-safe prototyping techniques established in the present disclosure will help bootstrap other animal-centered computing projects.

### Examples

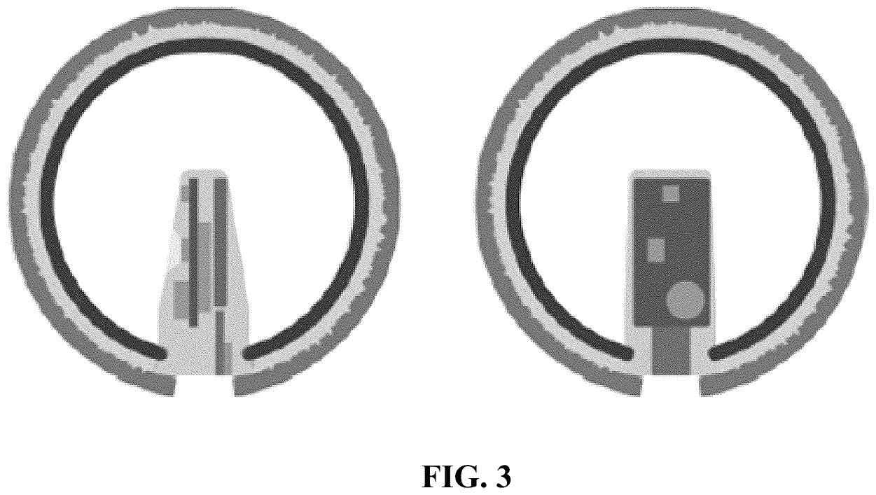

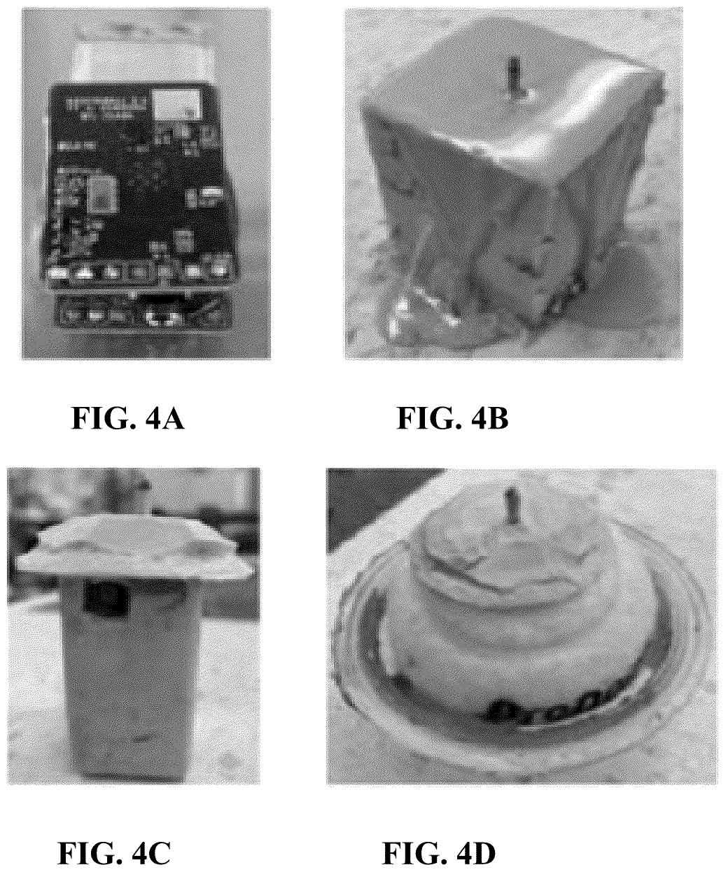

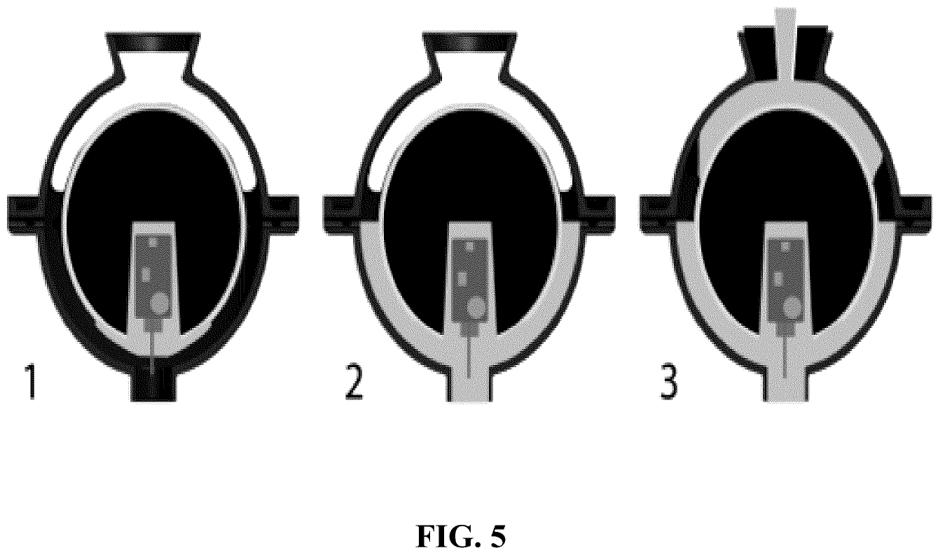

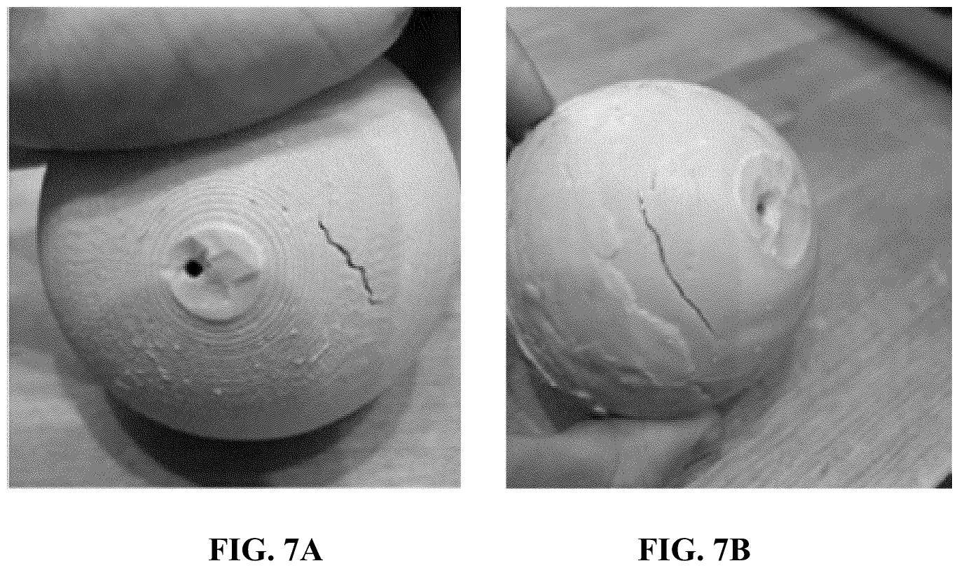

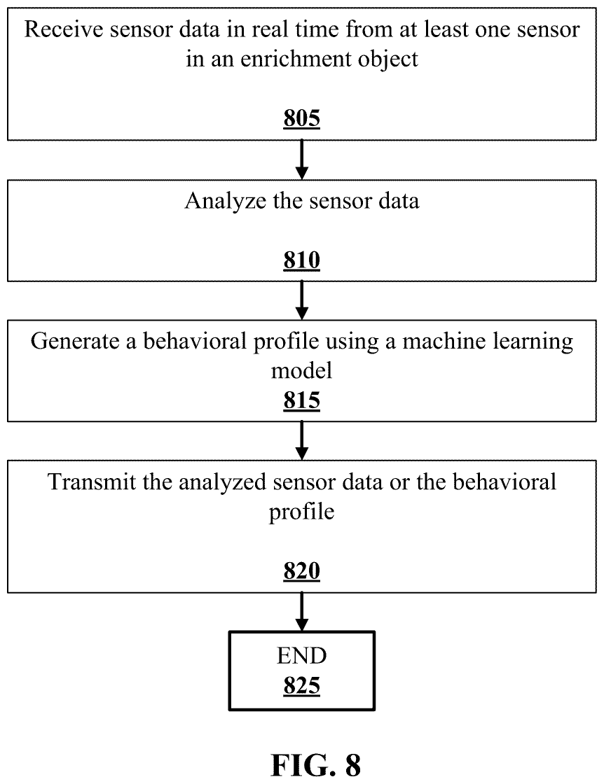

An exemplary method for using an enrichment object, such as a ball for generating behavior profiles will now be described with reference to FIGS. 1-8. Referring more specifically to FIG. 8, in step 805, the system can receive sensor data in real time from at least one sensor in an enrichment object, such as the ball. The present disclosure can utilize a variety of sensors embedded within the object to capture comprehensive data on the dog's interactions. These sensors can include an inertial measurement unit (IMU) to track motion, a barometric pressure sensor to measure bite force and pressure changes, an accelerometer to capture movements such as shaking, a gyroscope to detect rotational gestures, a magnetometer to synchronize data collection with video recordings, or combinations thereof. The data from these sensors can be transmitted in real time to a central system or computing device for analysis, providing valuable insights into the dog's behavior and health as described further below.

To further enhance the data collection process, the present disclosure can incorporate multiple enrichment objects (one or more balls), each equipped with any of the aforementioned sensors, or combinations thereof. This allows for the simultaneous monitoring of interactions with various objects, providing a more holistic view of the dog's behavior. For instance, different objects can be designed to elicit specific behaviors, such as a ball for fetching and a chew toy for biting. The different enrichment objects can be placed throughout an environment in some examples. By receiving and analyzing data from multiple objects, researchers can gain a deeper understanding of the dog's preferences, activity levels, and potential health issues. The integration of automated telemetry and magnetic switching features can streamline the data collection process, making it easier for researchers to deploy and maintain the system across different environments and study conditions. In these examples, the system can receive sensor data from at least a portion of the multiple objects for analyzation.

### Analyzing the Sensor Data

In step 810, the system can analyze the sensor data. The data preparation process can begin with the collection of the sensor data from the various sensors embedded within the enrichment objects. The IMU, which comprises an accelerometer, gyroscope, or a magnetometer, can capture motion data such as acceleration, rotational velocity, and magnetic field strength, respectively. This data can provide insights into the animal's movements, including bite force, frequency, shaking behaviors, heart rate, or combinations thereof. Using the accelerometer, the data can indicate breath rate, whether the animal is sniffing, or how hard the animal is panting. For example, if a dog is panting heavily, the system can differentiate between normal exertion and signs of distress or fatigue. Additional temporal sensors can be used to get the temperature of the animal. The barometric pressure sensor measures changes in air pressure within the toy, which can indicate the intensity of the dog's bite. In some examples, when the ball is solid, the system can more accurately measure the animal's bite force using the sensors within the ball.

This sensor data is then preprocessed to remove noise and irrelevant information, ensuring that only high-quality data is used for further analysis. Noise in the data can stem from various sources, such as environmental vibrations, electrical interference, or sensor drift. For instance, sudden spikes or drops in accelerometer readings that do not correspond to actual dog movements can be considered noise. Irrelevant information may include data points collected when the toy is not being actively engaged by the dog, such as when it is stationary or being handled by a human. By filtering out these extraneous elements, the preprocessing step ensures that the dataset accurately reflects the dog's interactions with the toy, thereby enhancing the reliability and validity of the subsequent analysis.

Once the data is preprocessed, the system can segment the sensor data into meaningful intervals that correspond to specific behaviors or actions performed by the dog. This segmentation process involves identifying and isolating distinct events, such as biting, shaking, or rolling the object. By analyzing these segments, the system can extract features that characterize the dog's interactions with the toy. For example, the accelerometer data can reveal the frequency and intensity of the dog's movements, while the gyroscope data can provide information about the orientation and rotation of the toy. The barometric pressure data can be used to estimate the force exerted by the dog during biting. These features are then aggregated to form a comprehensive dataset that represents the dog's behavior over time.

The prepared dataset is then organized and formatted for use in machine learning models. This involves normalizing the data to ensure consistency and compatibility across different sensors and measurement units. The dataset is also labeled with relevant metadata, such as the dog's breed, age, and training status, to provide context for the analysis. Additionally, the data is split into training, validation, and test sets to facilitate the development and evaluation of the machine learning models. By structuring the data in this manner, the system can effectively train models to identify patterns and predict outcomes related to the dog's behavior and health.

### Behavioral Profiles

Once the machine learning model is trained, in step 815, the system can generate a behavioral profile using a machine learning model. By examining the segmented sensor data of specific behaviors or actions performed by the dog or animal in the meaningful intervals, the model can identify patterns and correlations that are indicative of different behavioral phenotypes. These phenotypes can include temperament traits, activity levels, and even potential medical symptoms. The machine learning model can generate profiles that categorize dogs into different behavioral types, which can be used to tailor training programs, monitor health, and predict future behaviors.

The generated behavioral profiles can be highly detailed and multifaceted. For instance, a profile might indicate a dog's propensity for high-energy activities, its responsiveness to training commands, or its likelihood of exhibiting stress-related behaviors. These profiles can be invaluable for trainers and veterinarians, providing a data-driven basis for making decisions about training regimens, health interventions, and even suitability for specific roles such as service or working dogs. This information can be used to better match an animal to an adopter or a handler with a similar energy level, providing insights into possessiveness and compatibility between a potential owner and the animal. The present disclosure's approach to utilizing machine learning for behavioral profiling represents a significant advancement in the field of animal-centered computing, offering a robust tool for enhancing the well-being and effectiveness of service and working dogs.

### Additional Insights

In one example, in addition to generating a behavioral profile, the system can use the machine learning model to generate additional insights that can be useful related to the animal. For instance, the system can significantly enhance the work readiness of an animal by providing real-time monitoring and analysis of its behavior and physiological state. By utilizing the data collected from the enrichment objects, the system can assess changes in play behavior, engagement levels, and physical exertion throughout a shift cycle. Additionally, the system can track physiological indicators such as breathing patterns, temperature, and heart rate, providing a comprehensive view of the animal's readiness and overall health. For instance, a dog performing nose work can be monitored for signs of fatigue or decreased attention, with the system dispensing rewards based on performance metrics to maintain motivation. A dog on a work shift can be provided an enrichment toy as a reward during a break, which can serve as a check in on the health of the animal. The system can include an integration with smartphone apps allowing handlers in the field to visualize generated insight data from the machine learning model, ensuring that the animal remains focused and effective in its tasks. The system can do this by dynamically transmitting in real time the additional insights (such as the visualization) to a client device as the sensor data is received from the enrichment objects in real time. This real-time telemetry and behavioral assessment enable handlers to make informed decisions, ensuring that the animal is functioning optimally and is prepared for its duties.

Additionally, prior to indicating that an animal is prepared for its duties, additional measures can be taken by the system to determine whether the object or ball is working and whether the animal is ready. For example, the system can implement a series of diagnostic checks and readiness assessments. The system can continuously monitor the operational status of the enrichment objects by analyzing sensor data for signs of malfunction or wear. For instance, the system can detect irregularities in sensor readings, such as inconsistent accelerometer data or unexpected pressure changes, which may indicate a fault in the device. Additionally, the system can perform periodic self-checks to ensure that all sensors are functioning correctly and that the battery levels are sufficient for continued operation. These diagnostics can be displayed on a user interface transmitted to a client device to alert handlers to any issues that need attention. Concurrently, and in real time, the system can assess the animal's readiness by evaluating physiological and behavioral metrics from current sensor data against predefined thresholds. For example, if the system detects elevated heart rates, irregular breathing patterns, or decreased engagement levels, it can flag the animal as potentially fatigued or stressed. This information can be relayed to handlers through the integrated smartphone app, providing real-time updates on both the device's and the animal's status. By combining these diagnostic and readiness assessments, the system ensures that both the enrichment objects and the animals are in optimal condition for their tasks.

In other examples, the additional insights can include identifying the animal among a plurality of animals that are using the enrichment objects. Based on the different patterns of interactions known from a behavioral profile of an animal, a current animal user of the object can be differentiated among a group or a pack of animals. Additionally, using the behavioral profiles of the animals that use the object, the system is able to use the machine learning model to determine compatibilities between the animals based on the interactions each animal has with the enrichment objects.

In step 820, the system can transmit the analyzed sensor data or the behavioral profile. The system can transmit this data to a centralized database where it can be stored for further analysis and comparison. Additionally, the system can transmit to a graphical user interface for display a user-friendly dashboard accessible via a web application. This dashboard can provide real-time insights into the dog's behavior, allowing trainers, veterinarians, and researchers to monitor the dog's health and training progress. The data can also be integrated into existing canine health management systems, providing a comprehensive view of the dog's well-being over time.

### Environment Stimuli

Additionally, simultaneous multi-device data collection via wireless real-time telemetry can allow the system to design trials to enable pet owners, animal handlers, caretakers, and researchers to create systems that trigger environmental stimuli or rewards while the instrumented enrichment objects are in use. The system can dynamically retrieve imaging data in response to receiving the sensor data in real time from the enrichment object. When an animal interacts with the object, imaging devices like cameras can be activated to collect imaging data. This data can be sent to a client device for real-time visuals, allowing handlers to monitor the animal's behavior and environment. Additionally, the imaging data can be stored for later use in training the machine learning model, enhancing its ability to recognize and interpret various behaviors and interactions.

Moreover, the system can be configured to trigger other environmental stimuli or rewards based on the animal's interactions with the object. For instance, when a dog successfully performs a desired action, the system can dispense food as a reward, reinforcing positive behavior. Other environmental objects, such as additional toys or interactive elements, can be provided to keep the animal engaged and stimulated. These automated responses not only enrich the animal's environment but also provide valuable data for further analysis. By integrating real-time telemetry, imaging data, and environmental stimuli, the system creates a comprehensive and dynamic platform for monitoring and enhancing animal behavior and well-being.

Graphical User Interface with Real-Time Telemetry

In some examples, the system can use the real-time telemetry with a dynamic graphical user interface to track items of interest in an environment. For example, the animal using the ball can provide intelligent breadcrumbs through the dynamic graphical user interface to a handler. In search and rescue operations, the system can enable dogs to make markers using the ball, effectively leaving “intelligent breadcrumbs” that provide valuable information to handlers and other team members. When a dog encounters a significant location, such as a potential victim or a critical point in the search area, it can perform a specific gesture with the ball, such as biting, crunching the object, or shaking it in a particular manner. This action triggers the ball's sensors to record the event and transmit the data to a central system. The system can then log the location and context of the marker, displaying it on an interface accessible to the search and rescue team. This interface can show the breadcrumb trail left by the dog, allowing the next person in the search sequence to follow the path and understand the dog's findings. The system can also be remotely powered, ensuring continuous operation in various environments. In one example, the animal can wear a vest that can have a battery pack to remotely power the enrichment object or can serve as a beacon for a location of the animal in the environment. The vest can serve as a storage forward network by temporarily storing in the best data collected by sensors and then the vest can be configured to forward the data to a central database, client device, or the system when a connection is available. This allows the dogs to act as mobile data collection units, effectively deploying them to gather and transmit information from various locations. This capability enhances the efficiency and effectiveness of search and rescue missions by providing real-time, actionable intelligence. Additionally, the system can monitor the dog's physiological state while it is holding the ball during a search. Changes in breathing patterns, detected by the ball's sensors, can be surveyed alongside visual data captured by imaging devices such as cameras.

In other applications, such as detecting water leaks or marking specific locations in a nursing home, the system can allow dogs to leave markers by interacting with the ball. For instance, a dog trained to find water leaks can bite the ball to signal a discovery, with the system logging the location for maintenance teams. Similarly, in a nursing home, a dog can mark beds by interacting with the ball, providing caregivers with information on which residents may need attention. This multi-functional capability of the system ensures that dogs can effectively communicate critical information in various scenarios, enhancing their role in both search and rescue operations and everyday tasks.

Furthermore, the system can enable the data to be shared with other stakeholders through secure APIs. This can facilitate collaboration between different research institutions and training facilities, enhancing the overall understanding of canine behavior and health. The system can also generate automated reports that can be sent to the dog's caretakers, providing them with actionable insights and recommendations. By leveraging cloud-based storage and processing, the present disclosure ensures that the data is accessible from anywhere, enabling remote monitoring and intervention when necessary. At step 825, the process terminates.

### Computing Device Architecture

As desired, embodiments of the disclosed technology may include a computing device. It will be understood that a computing device architecture is described for example purposes only and does not limit the scope of the various embodiments of the present disclosed systems, methods, and computer-readable mediums.

The computing device architecture can include a CPU, where computer instructions are processed; a display interface that acts as a communication interface and provides functions for rendering video, graphics, images, and texts on the display. In certain embodiments of the disclosed technology, the display interface may be directly connected to a local display, such as a touch-screen display associated with a mobile computing device. In another example embodiment, the display interface may be configured for providing data, images, text, and other information for an external/remote display that is not necessarily physically connected to the mobile computing device. For example, a desktop monitor may be utilized for mirroring graphics and other information that is presented on a mobile computing device. In certain some embodiments, the display interface may wirelessly communicate, for example, via a Wi-Fi channel or other available network connection interface to the external/remote display.

In an example embodiment, the network connection interface may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof.

The computing device architecture may include a keyboard interface that provides a communication interface to a keyboard. In one example embodiment, the computing device architecture may include a presence-sensitive display interface for connecting to a presence-sensitive display. According to certain some embodiments of the disclosed technology, the presence-sensitive display interface may provide a communication interface to various devices such as a pointing device, a touch screen, a depth camera, etc. which may or may not be associated with a display.

The computing device architecture may be configured to use an input device via one or more of input/output interfaces (for example, the keyboard interface, the display interface, the presence sensitive display interface, network connection interface, camera interface, sound interface, etc.) to allow a user to capture information into the computing device architecture. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture or may be a separate device. For example, the input device may be an accelerometer, a magnetometer, a digital camera, a microphone, and an optical sensor.

Example embodiments of the computing device architecture may include an antenna interface that provides a communication interface to an antenna; a network connection interface that provides a communication interface to a network. In certain embodiments, a camera interface is provided that acts as a communication interface and provides functions for capturing digital images from a camera. In certain embodiments, a sound interface is provided as a communication interface for converting sound into electrical signals using a microphone and for converting electrical signals into sound using a speaker. According to example embodiments, a random-access memory (RAM) is provided, where computer instructions and data may be stored in a volatile memory device for processing by the CPU.

According to an example embodiment, the computing device architecture includes a read-only memory (ROM) where invariant low-level system code or data for basic system functions such as basic input and output (I/O), startup, or reception of keystrokes from a keyboard are stored in a non-volatile memory device. According to an example embodiment, the computing device architecture includes a storage medium or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system, application programs (including, for example, a web browser application, a widget or gadget engine, and or other applications, as useful) and data files are stored. According to an example embodiment, the computing device architecture includes a power source that provides an appropriate alternating current (AC) or direct current (DC) to power components. According to an example embodiment, the computing device architecture includes a telephony subsystem that allows the transmission and receipt of sound over a telephone network. The constituent devices and the CPU communicate with each other over a bus.

According to an example embodiment, the CPU has appropriate structure to be a computer processor. In one arrangement, the CPU may include more than one processing unit. The RAM interfaces with the computer bus to provide quick RAM storage to the CPU during the execution of software programs such as the operating system application programs, and device drivers. More specifically, the CPU loads computer-executable process steps from the storage medium or other media into a field of the RAM in order to execute software programs. Data may be stored in the RAM, where the data may be accessed by the computer CPU during execution. In one example configuration, the device architecture includes at least 125 MB of RAM, and 256 MB of flash memory.

The storage medium itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium, which may comprise a machine-readable storage medium.

According to one example embodiment, the term computing device, as used herein, may be a CPU, or conceptualized as a CPU. In this example embodiment, the computing device may be coupled, connected, and/or in communication with one or more peripheral devices, such as display. In this example embodiment, the computing device may output content to its local display and/or speaker(s). In another example embodiment, the computing device may output content to an external display device (e.g., over Wi-Fi) such as a TV or an external computing system.

In some embodiments of the disclosed technology, the computing device may include any number of hardware and/or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

The computing device architecture may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The computing device architecture may be configured to adjust model parameters during training. Model parameters may include weights, coefficients, offsets, or the like. Training may be supervised or unsupervised.

The computing device architecture may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The computing device architecture may be configured to optimize statistical models using known optimization techniques.

Furthermore, the computing device architecture may include programs configured to retrieve, store, and/or analyze properties of data models and datasets. For example, computing device architecture may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The computing device architecture may include algorithms to determine a data type, key-value pairs, row-column data structure, statistical distributions of information such as keys or values, or other property of a data schema may be configured to return a statistical profile of a dataset (e.g., using a data-profiling model). The computing device architecture may be configured to implement univariate and multivariate statistical methods. The computing device architecture may include a regression model, a Bayesian model, a statistical model, a linear discriminant analysis model, or other classification model configured to determine one or more descriptive metrics of a dataset. For example, computing device architecture may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The computing device architecture may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, computing device architecture may be configured to generate a similarity metric representing a measure of similarity between data in a dataset. A similarity metric may be based on a correlation, covariance matrix, a variance, a frequency of overlapping values, or other measure of statistical similarity.

The computing device architecture may be configured to generate a similarity metric based on data model output, including data model output representing a property of the data model. For example, computing device architecture may be configured to generate a similarity metric based on activation function values, embedding layer structure and/or outputs, convolution results, entropy, loss functions, model training data, or other data model output). For example, a synthetic data model may produce first data model output based on a first dataset and a produce data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The computing device architecture may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may and indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The computing device architecture may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, computing device architecture is configured to generate and/or train a classification model to classify a dataset, consistent with disclosed embodiments.

The computing device architecture may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the tree.) Each tree may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via a weighted connections. Prediction models may additionally or alternatively include classification and regression trees, or other types of models known to those skilled in the art. To generate prediction models, the computing device architecture may analyze information applying machine-learning methods.

The computing device architecture may include programs (scripts, functions, algorithms) to configure data for visualizations and provide visualizations of datasets and data models on the user device. This may include programs to generate graphs and display graphs. The computing device architecture may include programs to generate histograms, scatter plots, time series, or the like on the user device. The computing device architecture may also be configured to display properties of data models and data model training results including, for example, architecture, loss functions, cross entropy, activation function values, embedding layer structure and/or outputs, convolution results, node outputs, or the like on the user device.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the useful functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A system comprising:
at least one enrichment object comprising at least one magnetic sensor;
at least one processor;
a memory in communication with the at least one processor and the at least one magnetic sensor, and having stored thereon instructions that, when executed by the at least one processor, is configured to cause the system to:
analyze sensor data received in real time from the at least one magnetic sensor; and
generate a behavioral profile based, at least in part, on the analyzed sensor data.

2. The system of claim 1, wherein the sensor data is received in real time in response to a user interacting with the at least one enrichment object.

3. The system of claim 2, wherein the user is interacting with the at least one enrichment object in an environment comprising at least three magnetic sensors placed in known arrangements to track a relative posturing of the system relative to the user.

4. The system of claim 2, wherein the memory, when executed by the at least one processor, is further configured to cause the system to:
transmit a signal to an imaging device in an environment comprising the at least one enrichment object to initiate or terminate video data collection.

5. The system of claim 2, wherein the memory, when executed by the at least one processor, is further configured to cause the system to:
transmit a signal to an environmental stimulus in an environment comprising the at least one enrichment object.

6. The system of claim 5, wherein the environmental stimulus is a reward for the user interacting with the at least one enrichment object.

7. The system of claim 2, wherein the user is interacting with the at least one enrichment object in an environment, wherein the at least one enrichment object are a plurality of enrichment objects, wherein the memory, when executed by the at least one processor, is further configured to cause the system to:
simultaneously receive the sensor data and state data from the plurality of enrichment objects,
wherein the state data comprises mechanical or electrical failures of a corresponding enrichment object in the plurality of enrichment objects.

8. The system of claim 2, wherein the at least one enrichment object is a silicone enrichment object further comprising at least one accelerometer, at least one gyroscope, or at least one barometer.

9. The system of claim 8, wherein the sensor data is additionally received from the at least one accelerometer, the at least one gyroscope, or the at least one barometer, wherein the sensor data is automatically segmented, and wherein the sensor data is analyzed using a machine learning model by:
automatically detecting activities in the sensor data associated with the user interacting with the at least one enrichment object, wherein the sensor data is segmented based on the detected activities; and
generating the behavioral profile using the machine learning model by detecting patterns between the sensor data and the detected activities.

10. The system of claim 9, wherein the machine learning model is configured to dynamically generate a visual of the sensor data and wherein the memory, when executed by the at least one processor, is further configured to cause the system to:
transmit in real time the sensor data or the visual of the sensor data to an external device.

11. The system of claim 9, wherein a level of work readiness of the user is determined based on the behavioral profile of the user by comparing patterns of play in the behavioral profile to a current state of play.

12. The system of claim 8, wherein the sensor data is additionally received from the at least one accelerometer, the at least one gyroscope, or the at least one barometer, wherein the sensor data is automatically analyzed using a machine learning model to detect at least one signal from the user interacting with the at least one enrichment object.

13. The system of claim 12, wherein the user is interacting with the at least one enrichment object in an environment, and wherein the at least one signal is based on a bite pressure or a movement of the at least one enrichment object from the user.

14. The system of claim 13, wherein the at least one signal marks a location of the environment for a handler of the user.

15. A method comprising:
analyzing sensor data received in real time from at least one magnetic sensor in at least one enrichment object; and
generating a behavioral profile based, at least in part, on the analyzed sensor data.

16. The method of claim 15, further comprising:
transmitting a signal to an imaging device in an environment comprising the at least one enrichment object to initiate or terminate video data collection.

17. The method of claim 16, further comprising:
transmitting a signal to an environmental stimulus in an environment comprising the at least one enrichment object.

18. An enrichment object comprising:
a silicone shell;
at least one sensor inside of the silicone shell;
at least one processor; and
a memory in communication with the at least one processor and the at least one sensor, and having stored thereon instructions that, when executed by the at least one processor, is configured to:
transmit sensor data from the at least one sensor to a computing device for a generation of a behavioral profile based, at least in part, on the sensor data.

19. The enrichment object of claim 18, further comprising:
charging hardware configured to enable wireless charging of the at least one sensor through the silicone shell.

20. The enrichment object of claim 18, further comprising:
automatically detecting activities in the sensor data associated with a user interacting with the enrichment object, wherein the sensor data is segmented based on the detected activities; and
generating the behavioral profile in real time using a machine learning model by detecting patterns between the sensor data and the detected activities.
